(19) United States
(12) Patent Application Publication
(10) Pub. No.: US 2012/0080849 A1
(43) Pub. Date: Apr. 5, 2012

(54) Seal for Vertical Feed-Through of a Transmission Plug

(75) Inventors: Peter Zweigle, Ditzingen (DE); Franco Zeleny, Besigheim (DE)

(73) Assignee: Robert Bosch GmbH, Stuttgart (DE)

(21) Appl. No.: 13/262,231

(22) PCT Filed: Feb. 11, 2010
(86) PCT No.: PCT/EP2010/051732

§ 371 Date: Dec. 20, 2011

(30) Foreign Application Priority Data
Mar. 31, 2009 (DE) 102009002001.2

(51) Int. Cl. H02G 15/013

(52) U.S. Cl. 277/314; 277/602; 277/607; 277/615; 277/626; 277/627

(57) ABSTRACT

A seal for a perpendicular plug feed-through is disclosed for electrically contacting a control device which is arranged within a housing. The seal includes a sealing piece which has at least one sealing lip and which is surrounded by a guiding piece. The sealing piece has at least one sealing lip, which is designed in a circumferential manner or in alternating segmentation and which has a slope declining in the radial direction towards the outside.

### PRIOR ART

DE 197 11 939 A1 relates to an apparatus for detecting the pressure and the temperature in the intake pipe of an internal combustion engine. In a common housing, a temperature sensor is arranged on a support together with an evaluation circuit and a pressure sensor which is mounted in a largely low-stress manner. A nozzle part is mounted on the housing part for the purpose of introducing a pressurized medium. An intermediate piece which is connected both to the support and to the nozzle part is used, said intermediate piece being fixed by means of mechanical adhesive sealing bonds which decouple stresses.

DE 10 2006 049 924 A1 relates to a pressure measuring apparatus for motor vehicle applications. In said document, the pressure of a fluid medium is detected, with the pressure measuring apparatus having at least one pressure measuring cell which is accommodated in a sensor assembly and has an internal pipe for absorbing the pressure of the fluid medium. Furthermore, a probe assembly having an external pipe which can be introduced into the fluid medium is provided. The internal pipe projects into a pressure measuring channel of the external pipe, it being possible for said pressure measuring channel to be connected to the fluid medium. At least one sealing ring is provided between the internal pipe and the external pipe, the material of said sealing ring comprising a fluorosilicone rubber, in particular FVMQ.

EP 1 018 788 A1 relates to a housing seal for a plug connector. The plug connector comprises two connector parts which consist of a plug-in part and a receptacle part and can be plug-connected. The housing seal has three leaktight lips and is in the form of a flat linear sealing element in cross section. For the purpose of sealing the region between the two connector parts which can be plug-connected, one of the sealing lips is clamped in in the connecting direction between the two connector parts, and the two other sealing lips are located within the receptacle part.

In the case of automatic transmissions, in particular for use in the automobile industry, the electrical control modules can be arranged within the transmission housing. The electrical connection of said electrical control modules then has to be routed to the outside through the transmission housing. The plug also has to be routed through in a watertight and oiltight manner when there are positive or negative pressure differences which are marked by temperature differences. In the case of plugs which are installed vertically, it is necessary to prevent splash water collecting above the sealing point so that no liquid can be drawn in when the transmission is cooled.

In the case of seals which have been used to date on transmissions, be it on automatic transmissions or on manual transmissions, sealing bushes are used in order to compensate for positioning tolerances of the plug. The sealing bush comprises a rigid guide part which can be provided in the form of, for example, a deep-drawn metal part or a plastic injection-molded component, and an elastic sealing element. In the case of a vertical plug arrangement, the guide of the sealing bush generates an undesirable, annularly running cavity above the seal, it being possible for splash water to remain in said cavity. If the guide of the sealing bush is dispensed with, this cavity, in which splash water collects, can be minimized, but the guidance of the sealing bush solely by means of a sealing component which is composed of elastic material is inadequate.

### DISCLOSURE OF THE INVENTION

In line with the solution proposed according to the invention, a seal for a vertical plug feed-through through a housing is proposed, said seal having a guide part which is part of the housing to be sealed and which interacts with a sealing part which is produced from an elastic material, for example a plastic or from rubber.

The seal proposed according to the invention for a vertical plug feed-through is preferably an assembly having a two-component structure. One component is represented by an integrally formed collar, which is advantageously formed on the housing which is to be sealed itself, while the other component of the assembly is provided by a sealing element which is produced from elastic material and is in the form of a bush. In a particularly preferred embodiment, an end face of the collar, which is formed in the housing, is formed with internal individual segmentation. This means that a number of claw-like overhangs are formed along the circumference of the opening which is to be sealed, in each case an intermediate space being created between said overhangs. In a manner corresponding to the pitch of the claw-like overhangs on the collar over the circumference of the openings which are to be sealed, clearances are formed on the sealing bushes which are to be made in this opening, which is to be sealed, and have a formed sealing element, the claws of the guide part on the collar of the housing engaging over said clearances. Secondly, the bush-like sealing part which is produced from elastic material has individual projections which project into the clearances between the claw-like overhangs which are formed on the collar part. These projections on the sealing part serve as retaining segments and are likewise formed with individual segmentation in relation to the circumference of the sealing part which corresponds to the pitch of the individual segments of the collar part of the housing.

In a particularly preferred embodiment, the sealing part and the collar form two abutment surfaces in the region of the opening which is to be sealed. One abutment surface extends in the radial direction beneath the collar between the upper face of a screwed-on edge on the sealing element which is produced from elastic material, while the other extends in the axial direction in relation to the opening which is to be sealed and is provided by the inner face of the collar and the outer face of the bush-like sealing part. One or more sealing lips can run in the circumferential direction both on the inner face and in the region of the integrally formed edge of the bush-like sealing part.

In a particularly preferred embodiment, a circumferential sealing lip is located at the highest point of the bush-like sealing part. This sealing lip has a substantially triangular profile and has a bevel in relation to the end face of the sealing element, said bevel producing a gradient in the radial direction to the outside. On account of this slope and the gradient produced on the upper face of the sealing element which has a substantially triangular profile, splash water can be diverted away in the radial direction to the outside through the intermediate spaces between the claw-like overhangs, the retaining segments of the overhung sealing element, so that said splash water does not remain on the end face of the sealing element and, when the transmission is cooled, is not drawn into the interior of the transmission housing to be sealed.

The solution proposed according to the invention prevents a build-up of dammed water on the end face of the sealing part since this water is diverted away radially to the outside through the intermediate spaces over the circumference of the seal of the vertical plug guide.

The claw-like overhangs, which are formed in an alternating sequence, on the edge region of the openings to be sealed together with the retaining segments, which are formed with a corresponding pitch thereto, over the circumference of the sealing part ensure secure positioning of the seal when the sealing part is installed in the opening to be sealed and in the event of the changes in pressure which occur on account of the change in temperature of the housing which is to be sealed.

Whereas the sealing lip can be circumferential in a first design variant, this allowing simpler die design for production of the same, in a further advantageous design variant, the sealing lip can be formed in alternating order, that is to say with alternating segmentation. This means that, as seen in the circumferential direction of the opening which is to be sealed, the seal is formed by a recesses and projections which follow one another in alternating order, with the pitch in this case corresponding to the pitch of the claw-like overhangs at the edge region of the collar. This second advantageous design variant provides an optimal shape of the sealing part for discharge of splash water in the radial direction.

### BRIEF DESCRIPTION OF THE DRAWING

The invention will be explained in greater detail below with reference to the drawings, in which

FIG. 1 shows a perspective plan view of the seal for a vertical plug feed-through on a housing,

FIG. 2 shows an illustration, on an enlarged scale, of the guide part and sealing part with abutment surfaces which are produced,

FIG. 3 shows a relatively large perspective detail of the sealing part made in the opening to be sealed,

FIG. 4 shows a first design variant of the circumferential sealing lip on the sealing part, and

FIG. 5 shows the sealing lip on the sealing part formed with alternating segmentation.

### EMBODIMENTS

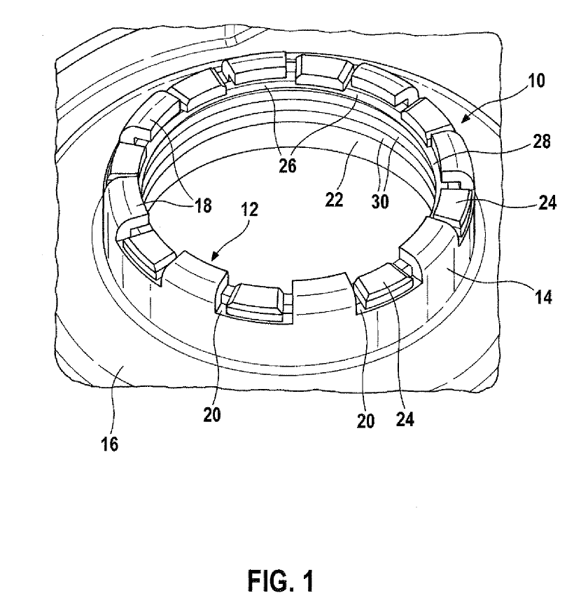

The illustration according to FIG. 1 shows a seal which serves to seal a housing from the ingress of water and the escape of oil or the like.

A seal 10, which serves, in particular, for a vertical plug guide for making electrical contact with components which are situated within a housing 16, comprises a guide part 12. The guide part 12 is part of a housing 16 and is formed by a collar 14. The collar 14, which projects at a virtual right angle in relation to the plane surface of the housing 16 from said housing, comprises, as seen in the circumferential direction of an opening which is to be sealed, a number of retaining segments 18. As seen in the circumferential direction of the opening which is to be sealed, the retaining segments 18 are arranged in alternating order, that is to say a cutout 20 is situated on the circumference of the opening, which is to be sealed, of the collar 14 between two retaining segments 18 which are arranged adjacent to one another.

A sealing part 22 is made in the the collar 14 which serves as the guide part 12, said sealing part preferably being produced from a material having elastic properties.

Retaining segments 24 which are integrally formed in alternating sequence, as seen in the circumferential direction 56, in relation to the cutout 26, are also located on the end face of the sealing part 22 which is produced from elastic material. The pattern, which is illustrated in FIG. 1, of retaining segments 18 and 24 engaging in respective cutouts 20 and 26 is produced when the sealing part 22 which has elastic properties is mounted.

As additionally shown by the perspective plan view according to FIG. 1, the individual flanks of the retaining segments 18 both of the collar 14 and also of the retaining segments 24, which are formed on the end face of the sealing part 22, do not rest flat one on the other but have small channel-like recesses in relation to one another. Reference symbol 28 denotes a sealing lip which is formed in a circumferential manner in the perspective view according to FIG. 1 and which is located on the end face of the sealing part 22 beneath the cutouts 26 and the retaining segments 24 which are formed on the sealing part 22.

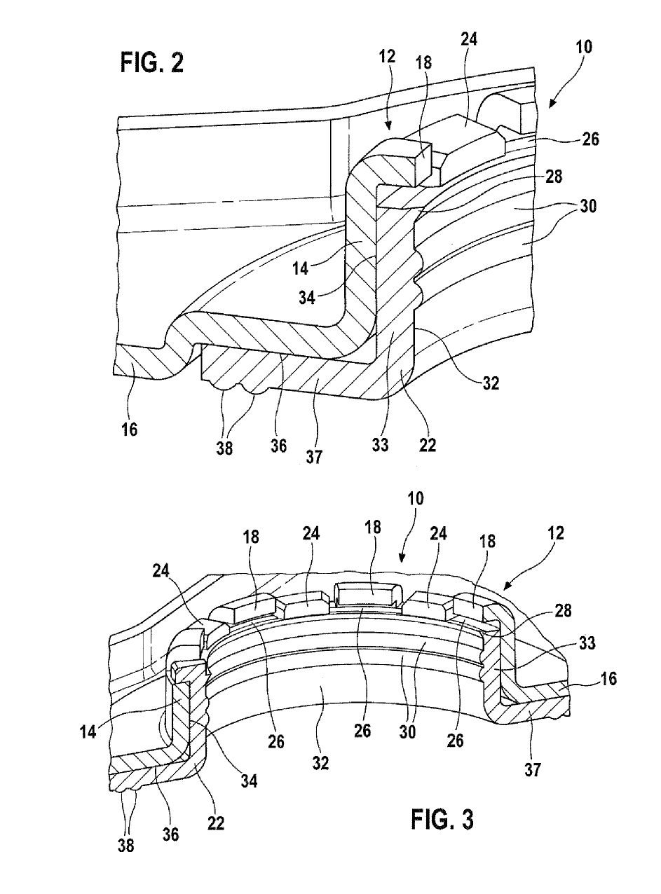

The illustration according to FIG. 2 shows a detail, which is illustrated on an enlarged scale, of the seal proposed according to the invention.

The illustration according to FIG. 2 shows that the sealing part 22 has at least one sealing lip 28 which runs in the circumferential direction 56. Said sealing lip extends on the end face of an axial sleeve attachment 33, two beads 30 which are arranged situated one above the other being formed on the inner face 32 of said axial sleeve attachment in the illustration according to FIG. 2. The axial sleeve attachment 33 of the sealing part 22 which is produced from elastic material merges with an integrally formed edge 37. Two concentric support beads 38 extend on the lower face of the integrally formed edge 37 of the sealing part 22 which is composed of a material having elastic properties.

The installation position of the sealing part 22 in the guide part 12 illustrated in FIG. 2 shows that a first abutment surface 34 is produced between the axial sleeve attachment 33, or the outer casing surface thereof, and the inner face of the collar 14, said first abutment surface 34 fulfilling a sealing function, and furthermore a second abutment surface 36 being produced by the lower face of the housing 16, which is planar here, and the upper face of the edge 37 which is integrally formed on the sealing part 22.

The perspective view according to FIG. 2 also shows that the retaining segments 18 of the collar 14 engage in cutouts 26 of the sealing part 22, whereas the retaining segments 24 of the sealing part 22 engage in the correspondingly designed cutouts 20 which are formed on the collar 14. The housing 16 according to the illustration in FIG. 2 can be both a deep-drawn part which is produced from metal material and a plastic housing.

FIG. 3 shows a half-section through the perspective view of the vertical plug feed-through according to FIG. 1.

The illustration according to FIG. 3 shows that the sealing lip 28, which is of circumferential design in the design variant according to FIG. 3, is located on the inner face 32 of the axial sleeve attachment 33 and runs above two beads 30, which are situated one above the other, on the inner face 32 of the axial sleeve attachment 33 of the sealing part 22. The illustration according to FIG. 3 shows, particularly instructively, how the retaining segments 18 of the collar 14 engage in correspondingly formed cutouts 26 of the sealing part 22, so that an overlap is formed and therefore the sealing part 22 is fixed, but with small clearances which extend in the radial direction remaining between the retaining segments 18, which are arranged situated next to one another, of the collar 14 and the retaining segments 24 of the sealing part 22.

In the illustration according to FIG. 3, reference symbol 34 denotes the first abutment surface, while reference symbol 36 denotes the second abutment surface between the housing 16 and the integrally formed edge 37 of the sealing part 22.

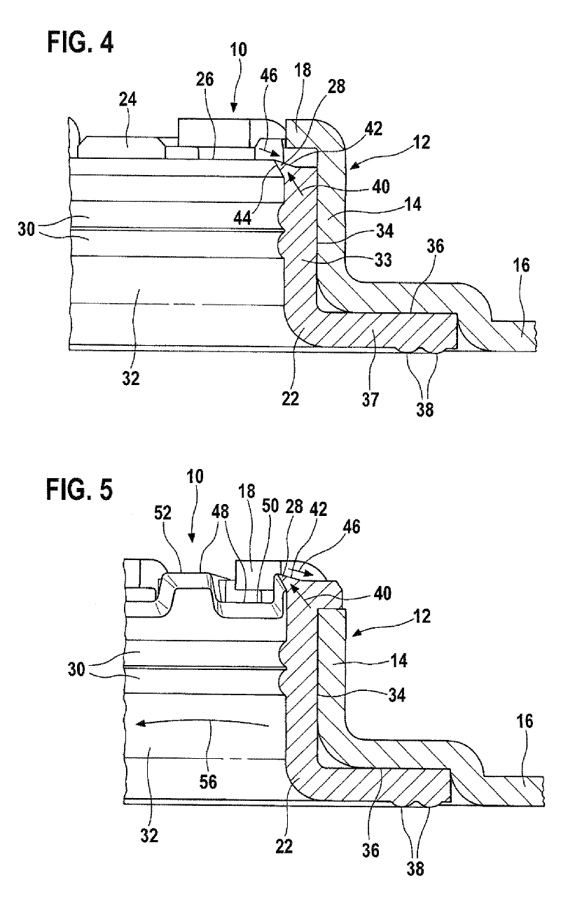

The illustration according to FIG. 4 shows, in a perspective reproduction, a first embodiment of the sealing part 22.

As FIG. 4 shows, the sealing lip 28, which is of circumferential design in this design variant, has a substantially triangular profile 44. The tip of the triangle which runs acutely radially to the inside is raised in relation to the end face of the axial sleeve attachment 33, that is to say is situated higher than the end face, and therefore a slope 42 which is inclined radially to the outside is produced. As a result, in the mounted state of the seal 10, water which collects on the end face or the slope 42 is guided radially to the outside and can flow away through the intermediate spaces between the retaining segments 18, which are adjacent to one another, of the collar 14 or the retaining segments 24 of the sealing part 22 in the radial direction in the outflow direction 46 to the outside onto the housing 16. This effectively prevents splash water collecting on the upper face of the seal 10 which, when the housing 16, for example a transmission housing, is cooled, would allow this splash water to be drawn into the transmission, this having to be avoided at all costs in order to not adversely affect the properties of the transmission fluid.

Similarly, the illustration according to FIG. 4 shows that, in the mounted state of the sealing part 22, the first abutment surface 34 is produced between the casing surface of the axial sleeve attachment 33 and the inner face of the collar 14, whereas the second abutment surface 36 is produced between the upper face of the integrally formed edge 37 of the sealing part 22 and the lower face of the planar boundary surface of the housing 16.

Reference symbol 40 indicates the raised portion of the sealing lip 28, which is of circumferential design in the illustration according to FIG. 4, in the vertical direction, so that the slope 42 is produced, said slope ultimately allowing collected splash water to flow away.

The illustration according to 5 shows a further embodiment of the seal 10, in which the circumferential sealing lip 28 has alternating segmentation 48. The alternating segmentation 48 is provided by a projection following a recess 50, as seen in the circumferential direction 56 of the sealing part 22. The projections 52 have, analogously to the circumferential sealing lip 28 according to the first embodiment in FIG. 4, a raised portion 40, so that splash water runs off to the outside in the radial direction in accordance with the outflow direction 46 onto the housing 16 or the surface which is situated beneath the collar 14. Recesses 50, which are situated in the region of cutouts 20 of the collar 14, run between the individual projections 52 which have an incline or slope 42.

Whereas a particularly simple die design can be achieved in the design variant illustrated in FIG. 4 when a circumferential sealing lip 28 is formed, the more complex geometry, which is reproduced in FIG. 5, of the at least one sealing lip 28 on the sealing part 22 has the advantage that an optimum shape in terms of waste water outflow is achieved.

Secure positioning of the seal 10 when it is installed in the housing 16 and when changes in pressure occur in the housing 16 is achieved with the retaining segments 18, which are arranged in an alternating manner and are illustrated in FIGS. 1, 2 and 3, of the collar 14 on the guide part 12 and the retaining segments 24 in relation to the sealing part 22.

1. A seal for a vertical plug feed-through for making electrical contact with at least one controller which is arranged within a housing, comprising:
a sealing part which has at least one sealing lip, and
a guide part surrounding the sealing part,
wherein the at least one sealing lip is formed on the sealing part in a circumferential manner or with alternating segmentation said sealing lip forming a slope which drops radially to the outside.

2. The seal as claimed in claim 1, wherein:
the sealing part includes an axial sleeve attachment, and
the at least one sealing lip is integrally formed on an end face of an inner face of the axial sleeve attachment.

3. The seal as claimed in claim 1, wherein the alternating segmentation of the sealing lip is formed by recess and projections which are arranged in an alternating manner in the circumferential direction.

4. The seal as claimed in claim 1, wherein the guide part and the sealing part each have retaining segments and cutouts which are arranged in alternating order as seen in the circumferential direction.

5. The seal as claimed in claim 1, wherein the sealing lip has a substantially triangular profile.

6. The seal as claimed in claim 1, wherein:
the sealing part includes an axial sleeve attachment, and
the sealing lip runs in a manner raised obliquely in relation to an end face of an inner wall of the axial sleeve attachment.

7. The seal as claimed in claim 1, wherein the sealing part comprises at least one bead on the inner face and at least one support bead on an integrally formed edge.

8. The seal as claimed in claim 1, wherein the sealing part includes an axial sleeve attachment, and further comprising:
a first abutment surface formed between an inner face of a collar of the guide part and the axial sleeve attachment.

9. The seal as claimed in claim 8, further comprising a second abutment surface formed between the housing beneath the collar of the guide part and the integrally formed edge.

10. Use of the seal as claimed in claim 1 for sealing a vertical plug feed-through on a housing.

11. Use of the seal as claimed in claim 10, wherein the housing is a transmission housing of an automatic vehicle transmission.
